(19) United States
(12) Patent Application Publication
(10) Pub. No.: US 2005/0233200 A1
(43) Pub. Date: Oct. 20, 2005

(54) Process to manufacture an ion-permeable and electrically conducting flat material, the material obtained according to the process, and fuel cells

(76) Inventor: Balthasar Miller, Aarau (CH)

Correspondence Address: NIXON & VANDERHYE, PC, 901 NORTH GLEBE ROAD, 11TH FLOOR, ARLINGTON, VA, 22203, US

(21) Appl. No.: 10/516,953

(22) PCT Filed: Jun. 6, 2003
(86) PCT No.: PCT/CH03/00366

§ 371 Date: Apr. 7, 2005

(30) Foreign Application Priority Data
Jun. 6, 2002 (CH) 969/02

(51) Int. Cl. H01M 2/14; H01M 2/02; H01M 2/00; H01M 8/10

(52) U.S. Cl. 429/38; 429/39; 429/34; 429/33

(57) ABSTRACT

A fibrous, flat and ion-permeable material made of synthetic fibers, in particular of synthetically spun fibers such as acrylic fibers or aramid fibers, is processed into staple fibers of a specific length and then fibrillated. In a wet-laid inclined machine (paper machine), the fibrillated fibers are formed into a continuous web and then the web or portions of it are subjected to a temperature treatment to make the web electrically conducting by carbonizing/graphitizing the web through heating.

This invention pertains to a process to manufacture a fibrous, flat and ion-permeable material made of synthetic fibers, as well as a material produced according to the process, and a fuel cell.

### PRIOR ART

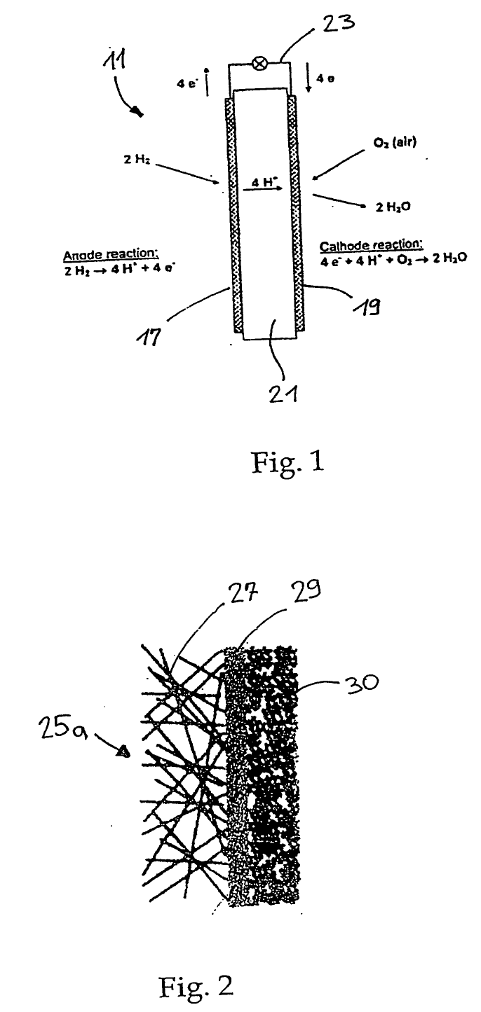

A fuel cell is used to convert energy electrochemically into electrical energy. One known fuel cell is the so-called polymer electrolyte fuel cell, the distinguishing characteristics of which is that a protonically conducting, electrically non-conducting polymer membrane is used as the solid electrolyte (FIG. 1). The solid electrolyte performs the dual function of an electrolyte (ionic conductivity via protons, transport number 1) and that of a separator (separation of the reactant gases hydrogen and oxygen). A known polymer electrolyte fuel cell contains a cathode and an anode, each of which contains a gas diffusion layer made from a carbon fiber web. The cathode and the anode are separated from one another by the polymer electrolyte membrane, which is electronically non-conducting, but nevertheless facilitates ion exchange. Standard membranes used today largely include perfluorinated membranes, for example Nafion® made by DuPont Nemours or Femion®, which is made by Asahi Glass. In order to make the perfluorinated membranes electrically conducting, platinum or platinum alloys are used First of all, this is to prevent corrosion of the electrocatalyst, and secondly to facilitate the necessary conversion per unit surface (current density) of the electrochemical reaction at low overvoltages at these relatively low temperatures.

In order to keep the material costs of the fuel cell low, platinum is supported on carbon (Pt/C high dispersion) and then applied as a thin layer, blended with ionomer material, to the membrane or to the gas diffusion layer through spraying, pouring etc. The electrochemical reaction takes place at the boundary between the ion-conducting material (membrane) and the electron-conducting catalyst particles. In the process, it is important for the catalyst particles to be electrically connected to one another. (percolation).

Due to the low perpendicular conductivity of the catalyst layer, it must be connected electronically (electron conductance) over its entire active surface in the requires a mat perpendicular direction to a current-supplying gas diffusion layer that acts as a current collector. This erial that on the one hand is sufficiently dense at the associated conductivity so as form as many points of contact in the catalyst layer as possible, and on the other hand is kept as open as possible (porous) so that the mass flow of the reactants can proceed from the rear of the gas diffusion layer. The gases are distributed through the channels of the bipolar plate from the rear and flow through the cell parallel to the rear of the gas diffusion layer, with a portion of the gas being transported perpendicular to this plane (flow direction) through the gas diffusion layer to the active layer.

On the cathode side, the reaction product, “water”, must be discharged in fluid form. This requires that the gas diffusion layer have certain “non-wetting” surface characteristics so that the gas diffusion layer does not flood. This is accomplished by impregnation with e.g. a PTFE suspension followed by tempering. On a mass basis, PTFE loads of up to 30% are typical. This results in a distribution of so-called hydrophobic pores (for gas) and hydrophilic pores (for water), which is important for the functioning of the gas diffusion layer. It is not required that the gas diffusion layer on the cathode side be identical with that on the anode side.

The manufacture of the permeable membrane (=carbon cloth) is very expensive. For example, known support materials used are carbon fiber cloths, baths, webs or similar.

EP 0 834 936 discloses a non-woven fabric made of inorganic and organic fibers for separators of non-aqueous electrolyte batteries, which is produced by a wet paper making process. The non-woven fabric has a thickness non-uniformity index (Rpy) of 1000 mV or less in machine direction. Further, the fabric has a center surface average roughness SRa of 6 □m or less in whole wavelength region measured by a three-dimensional surface roughness meter The fabric contains organic polypropylene, polyethylene, polymethypentene or acrylic fibers, which have the function of heat fusion bonding fibers. In addition, the fabric contains heat resistant fibers selected from the group of aramid fibers, polyphenylene sulfide fibers, polyarylate fibers, polyether ketone fibers, poyimide fibers, polyether sulfone fibers and poly-p-phenylenebenzobisoxazole fibers having a melting point or heat decomposition point of 250° C. or higher. For manufacturing the fabric the organic fibers are cut to lengths of 1 to 30 mm, preferably to 5 mm or less, and the raw material is dispersed in water in a concentration of up to 25%, preferably in a concentration between 1 and 10%. The suspension thus formed is repeatedly passed through a high pressure homogenizer for splitting the fibers parallel to the fiber axis (fibrillation). The fabric is manufactured by a wet paper making process and is then subjected to a hot calendaring treatment at a temperature of 50-200° C. At this temperature range no carbonizing of the fibres takes place. The non-woven fabric has a weight of 5-100 g/m², preferably 10-50 g/m².

U.S. Pat. No. 3,047,455 relates to the manufacture of paper or nonwoven products comprising randomly intermingled discontinuous fibers which are at least in part composed of highly fibrillated synthetic non-cellulosic fibers of paper-making lengths U.S. Pat. No. 3,047,455 teaches the use of wet spun synthetic, in particular acrylic fibers. Wet spun synthetic have a coarse, sponge-like structure and can surprisingly be used for manufacturing paper. The wet spun fibers are cut to staple lengths, suspended in water and battered in a conventional beater, whereby the fibers are fibrillated. The beaten fibrillated acrylic fibers are thereafter formed into a paper product by any suitable process using standard paper mill equipment. The paper products are then dried at a temperature ranging between room temperature and the temperature at which the acrylic polymer degrades or melts.

The objective of this invention is to propose a process by which a porous, flat, electrically conducting and ion-permeable material can be produced cost effectively, and preferably in a continuous process. Another goal is to prepare a flat, ion-permeable material that can be used in fuel cells in particular. A further object is to provide a fuel cell with improved gas diffusion layers, which can be manufactured more cost-effectively and in a continuous process.

### DESCRIPTION OF THE INVENTION

As specified by the invention, in a process according to the preamble of claim 1, staple fibers of a specific length are first fibrillated, then formed into a continuous web by means of a paper machine, preferably in an inclined wet-laid wire machine, and the web or sections thereof are subjected to a calendaring process und subsequently to a temperature treatment to obtain its electrical conductivity by carbonizing/graphitizing. The process according to the invention permits a gas-permeable material to be manufactured cost-effectively that can be employed as a gas diffusion layer in polymer electrolyte fuel cells. Surprisingly, it has been successfully shown that it is possible to manufacture a micro porous material made of synthetic fibers using the wet-laid paper-making manufacturing process of forming a fibrous web or felt, and to make this fibrous material electrically conducting, i.e. ion-permeable, by subsequently converting the synthetics to carbon/graphite. This is in contrast to the prior art, according to which carbon fibers are employed who are already electrically conductive and to process these into a flat material or layer.

According to the conventional process, carbon fibers are processed into an open non-woven web having a pore size of typically >100 μm. In order to obtain the desired micro porosity with pores <5 μm, the flat, wide-pore material is impregnated with carbon powder. The disadvantage of an impregnation with carbon powder, however, is that the surface of the diffusion layer is not smooth, but rather has a texture that corresponds to the particle size of the powder. In contrast thereto and according to the invention the desired microporosity can be obtained by using a paper-making manufacturing process.

The material manufactured according to the invention can perform the same function as the known gas diffusion layers used in polymer electrolyte fuel cells. The process according to the invention has the technical and economical advantage of being able to form a micro porous continuous web material cost-effectively in a continuous production process employing relatively simple technical means at efficient production speeds.

Advantageously, the carbonization or graphitizing process takes place at a temperature of greater than 600° C., preferably greater than 800° C., and very much preferred greater than 1000° C. In these temperature ranges the polymeric organic fibres can readily be transformed into carbonized/graphitized fibres, which are electrically conductive.

Advantageously, the web is melted at least partially by a first temperature treatment that at least partially softens or melts the fibres and forms said web and precedes the carbonizing/graphitizing temperature treatment (second temperature treatment). The advantage in this is that the web develops a more dense and less porous cover layer on its surface. By appropriately selecting the temperature and pressure during the calendaring process and the degree of fibre fibrillation at the employed fibres, the desired micro porosity of the layer, in particular of a cover layer being integral with the web, can be achieved. It is to be understood that the web can be made from two or more single webs and laminated to a single web.

It is advantageous for the staple fibers selected to have a cut length of between 4 and 40 mm, preferably between 8 and 12 mm and being preferably of a size of 0.5 dtex to 3 dtex.

It is preferred to fix the flat material in a tenter frame prior to the carbonization/graphitizing process. To the surprise of the inventor, the pore size does not change notably during the carbonization process. It is advantageous to suspend the staple fibers in a solvent, preferably water, to form a pulp or pulp of fibres to be fibrillated. The fibrillation (formation of small frays on the fibers) is best performed in a refiner, preferably a Jones Refiner. It is advantageous if the portion of staple fibers by weight in the pulp, i.e. the pulp dilution in the refiner, that is fibrillated in the refiner is between approximately 0.1 and 0.01 weight percent, preferably between 0.05 and 0.02 weight percent. Good results were obtained with these fractions.

A mixture of fibrillated and non-fibrillated fibers can be used to form the webs. This permits the porosity of the web to be controlled. The webs can have a specific or substance weight of typically between 45 to 150 g/m². It is advantageous to use fibers with a Titer of up to 15 dtex maximum, preferably up to a maximum of 8 dtex, and especially preferred with a Titer up to a maximum of 3.0 dtex. Preferably, the Titer of the fibres used ranges between of 0.5 dtex and 3 dtex.

According to an advantageous embodiment variant, synthetic fibers of at least a first and a second type are used. These fibers can consist of chemically different synthetic materials or can contain additives. These fibres may be different e.g. as to their composition, stability and/or melting point. Thus, a portion of the synthetic fibers used can contain a noble metal, for example platinum or gold. The noble metal can have the function of a catalyst.

It is advantageous to calendar the flat material or web at least once prior to carbonization. This can result in a densification of the upper layer, especially if the calendaring process is carried out at increased temperatures, and preferably simultaneous with the first temperature treatment. It is preferred to calender the material at least twice before carbonization, and such that the first calendaring step densifies all of the material and the second calendaring step modifies one or both of the paper surfaces into a film-like, micro porous material by softening the fibrillated fibers and creating a film-like micro-porous surface or cover layer of the web. In the process, the effect of the heat and the pressure can be selected such that the calendared material has the desired pore size afterward, for example <5 μm, preferably <2 μm. Non-crystalline synthetic fibers, for example acrylic, polyacrylate or aramid fibers, can be employed.

The object of this invention is also the provision of a fibrous, flat (two-dimensional) and porous material obtained via a process according to one of claims 1 through 19.

A further object of this invention is a non-woven fabric, which comprises or essentially consists of carbonized/graphitized polymeric fibres, in particular such a fabric having pore sizes of less than 10 μm and preferably less than 5 μm, and most preferably less than 2 μm. Said fabric can be coated with a catalyst layer and/or with a electrically non-conductive, ion-permeable membrane (PEM). In a preferred embodiment the the fabric has a core having a first porosity and at least one cover layer having a second porosity, said second porosity being less porous than the first porosity.

A further object of this invention is a fuel cell with at least two gas diffusion layers that are separated by means of an electrically non-conducting, but proton permeable separating wall or membrane, and that can be layered with at least one catalyst such as platinum, said fuel cell being characterized in that the gas diffusion layers are made at least in part of a material according to one of claims 20 to 22 and non-woven fabric according to one of claims 23 to 29. The object of this invention is also the use of a material obtained according to one of claims 1 through 19 as a microporous support for a membrane, in particular for a proton exchange membrane (PEM).

The invention is described in more detail below with reference to the attached figures. Shown are:

FIG. 1 A sketch showing the principals of a fuel cell with a proton-permeable membrane (polymer electrolyte membrane=PEM)

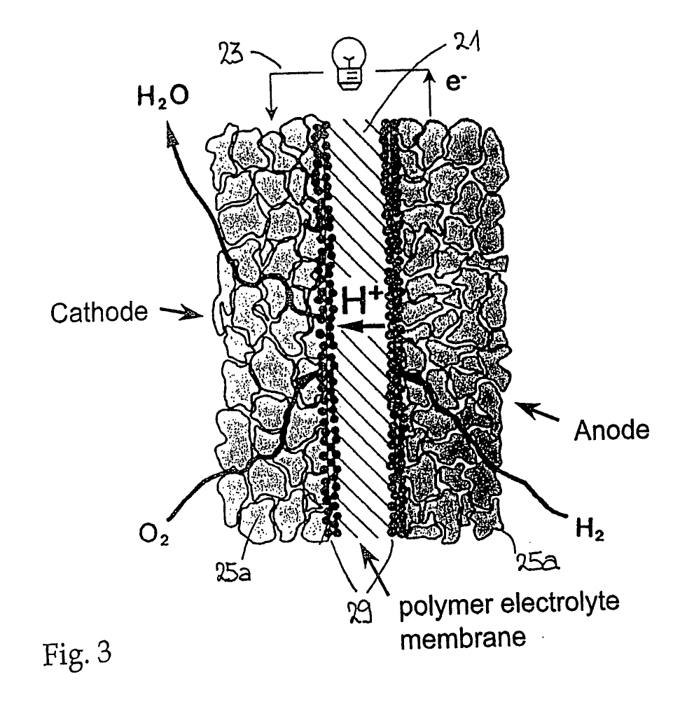

FIG. 2 A sketch of a known gas diffusion layer made of carbon fibers;

FIG. 3 The design of a known polymer electrolyte fuel cell with two gas diffusion layers separated by an ion-permeable membrane, shown schematically;

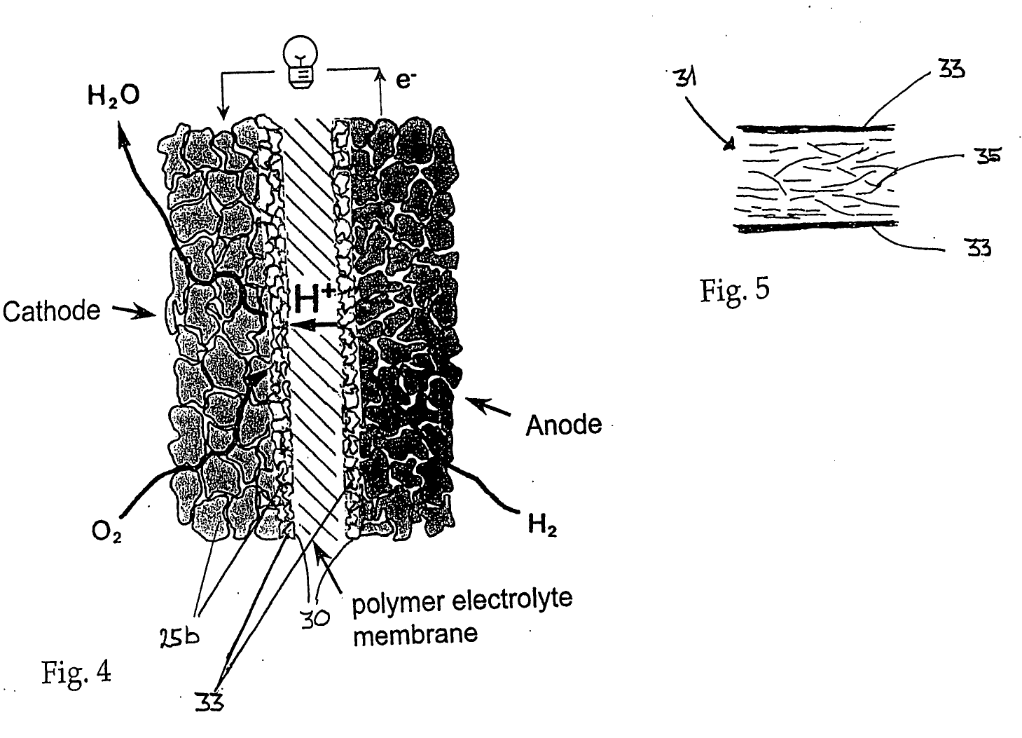

FIG. 4 The principal of a polymer electrolyte fuel cell with two gas diffusion layers according to the invention, shown schematically; and

FIG. 5 A cross section through the novel, flat material produced according to the process and described invention.

A known fuel cell 11 has two electrodes, an anode 17 and a cathode 19, which are placed at or attached to the opposite surfaces of a proton-permeable, electrically non-conducting membrane 21. Hydrogen is oxidized at the anode 17 and the hydrogen ion that arises from the oxidation passes through the proton-permeable membrane (PEM) 21 and reaches the cathode 19. The electrons make their way through the external, closed electrical circuit 23 to the cathode 19, performing electrical work in the process. At the cathode 19, each hydrogen ion absorbs an electron and reacts to form water in the presence of oxygen.

FIGS. 2 and 3 show a known polymer electrolyte fuel cell in more detail. The cathode 19 and anode 17, each of which has a gas diffusion layer 25a, are made of a micro porous material that is permeable to the reactant gases hydrogen and oxygen as well as to water. The conventional gas diffusion layers 25a are produced from a carbon fiber web 27 that is impregnated on one side with a carbon impregnation 29. The carbon impregnation 29 consists essentially of carbon/graphite dust. The carbon dust performs the additional function of providing the desired micro porosity of the gas diffusion layers 25a. On top of the carbon impregnation 29 is a platinum layer 30 that acts as a catalyst. Instead of a separate platinum layer 30, platinum can also be mixed in with the carbon dust of the carbon impregnation 29 as a catalyst in order to make the layer electrically conducting.

In contrast with the known polymer electrolyte fuel cells, the gas diffusion layer 25b of the cell according to the invention is produced from fibrillated synthetic fibers 31. The surface of the layer is more dense on at least one side (cover layer 33) than in the rest of the layer (FIG. 4). The surface is densified preferably through calendaring at a specific increased temperature. In this way, a micro porous material can be obtained that is permeable to hydrogen and oxygen. One advantage to the gas diffusion layer according to the invention is that the surfaces are very smooth so that platinum can be applied as a film-like, but porous layer.

FIG. 5 shows a cross section through a novel, flat material produced by the process according to the invention. The material has a central fibrous and porous core 35 and micro porous cover layers 33 on the surfaces that are more dense than the fibrous region 35. The fibrous core 35 and the fibrous cover layers 33 are made up essentially of staple fibers of a specific length. The staple fibers of the cover layers 35 are more dense, preferably as a result of single or multiple calendaring, and are partially softened.

The process to manufacture the flat, electrically conducting material is described in more detail below by means of example:

To produce staple fibers, synthetic fibers, preferably synthetic acrylic fibers, are first cut to a specific length, preferably between 8 and 12 mm. Then, a pulp is made consisting of the staple fibers and water. It is advantageous to fibrillate the fibers in a Jones refiner at a material density of approximately 0.5 to 0.02%. It has been shown that fibers with a Titer of 1.2 dtex to 3.0 dtex and cut-lengths from 8 to 12 mm are best suited to provide a good fibrillation result and a good sheet structure. The dimensions of the fibrils depend on the polymer structure. In the case of acrylic fibers, it has been observed that fibrils of up to 2 mm in length occur and have a diameter of approximately 0.2 μm. The more fibrils that can be produced at the individual fibers, the denser the fiber cloth becomes. It is advantageous for the refiner to have a cutting angle of <5° and the cutting surface gaps should not exceed ⅔ of the fiber length. The material of the refiner cone can be made of metal or also basalt.

A portion of the above fibers is left in their original, non-fibrillated state, being later mixed into the pulp of the fibrillated fibers. This increases the porosity of the middle layer of the finished material. A secondary effect is the increase in stiffness and tensile strength/working strength. The non-fibrillated fibers can also be so-called sheet core fibers. Here, the non-fibrillated fiber can have an even smaller fiber diameter than the fibrillated fiber, so as to prevent the formation of larger pores. The fibrillated fibers are further diluted after treatment in the refiner, and mixed with other types of fibers if necessary, for example those that support a catalytic process. The dilution helps to prevent the formation of fiber bundles, flocks and knots. The dilution also helps the fibers to deposit evenly when later forming the paper web in the subsequent inclined-wire-head box. More dilution of the stock takes place downstream of the machine [stock] chest on the way to the head box such that the final needed dilution level of the fibrous material of 0.0004% to 0.00015% in water is achieved prior to it. This extreme dilution is advantageous in ensuring an even, highly uniform fiber distribution on the paper machine wire by making sure each fiber is deposited individually. Commonly, dewatering and sheet formation is done at the inclined wire inside the head box. At the outlet lip of the inclined-wire-head-box, the web then appears in its final consolidated form. The subsequent dewatering of the paper web through suction under the machine wire after the head box, as performed on a fourdrinier type paper machine (PM), is not needed when employing an inclined wire-head box, commonly used for forming wet-laid-nonwovens.

The now finished paper web leaves the paper machine wire and moves freely along the supporting transport wire of the drying section. This can be a flat bed flow-through dryer, in which the air stream fixes the web onto the filter and the remaining water between the fibers is dried by the air passing through it. Because the fibers are fibrillated, and because the fibers had matted during the sheet formation in the head-box, the web has sufficient internal strength that it can be pulled freely by itself from support roll to support roll and densified in a calendar. It can then be rolled up.

What is novel is that a paper product of this type, after suitable repeated calendaring, is in such a form that a micro-porous filtering or separating material arises, from which an electrically conducting separating material and gas diffusion layer can be achieved by subsequently carbonizing/graphitizing the entire material. The carbonized material described here can then be used as a micro-porous support for a PEM membrane (proton exchange membrane) or the like. The membrane material can then be refined with a catalyst layer or the like so as to acquire additional functions.

The fibrillation of the fibers and the subsequent treatment in the calendar is important for the formation of the pores. In particular, the temperature control of the calendar, and the overall work energy balance of the calendar, must be taken into account. The energy balance must be established according to the polymeric structures, and is an important parameter in the reproducibility of the product. For example, it has been shown for an acrylic fiber paper with a weight of 60 g/m² that an initial calendaring at approximately 85° C. and a line load of 60-70 kp/cm and a second calendaring at 105° C. to 120° C. and a line load of 75 kp/cm results in a reproducible pore size of <2 μm. The speed of the paper web was 12 to 24 m/min during these tests. In the second calendaring pass, a film-like skin formed on the surface of the paper since the acrylic becomes plastic as a result of the added energy. However, due to the initial fibrillation of the fibers, this skin remains micro-porous. Beneath it, then, is a layer of non-melted fibers, which however were densified very compactly in the calendaring. This porous middle layer fills fully with the substance to be separated and distributes it very evenly to the second melted layer on the opposite side, or the bottom of the paper, from which it can then exit.

Experiments have demonstrated that the pores do not change, or only slightly, if the paper had been fixed in a tenter frame prior to the carbonization process. The carbonization of the web, i.e. of the flat material, can proceed in stages at temperatures between 600° C. and 1400° C. It is preferred that the final full carbonization take place at temperatures above 1000° C. and in particular above approximately 1150° C., preferably at approximately 1250° C. The necessary electrical conductivity for use in fuel cells can be produced through carbonization.

Any calendar can be used for the calendaring provided that it can apply the necessary work energy to deform the fibers (work energy=paper temperature+heat added+line pressure+drive power). The roll coating materials can consist of cotton or other fibrous materials (for example polyimide, aramid, mixed with other fibers and also as coated fibers, for example with a sputtered aluminum layer) It is recommended that as many of the parameters as possible be maintained as control parameters of the calendar being used in order to guarantee reproducibility. However, it has also been shown that results can be obtained with a pair of rolls steel on steel. The experiments were done using a multi-roll calendar and the results showed that it is of no consequence to the technical result whether a calendar has only two nips or has more of them. Multiple nips have the advantage of higher productivity and better quality assurance, and these have been known processes for a long time already in classical high densified capacitor—paper manufacturing.

The finished calendared paper made from synthetic fibers has a milky appearance and exhibits some opacity. Calendaring can approximately triple tensile strength in comparison to the state of the material after it's dried. The raw density is 0.65 to approximately 0.99 g/cm³. The paper is rolled up onto a core. To convert the paper into a carbon product, the paper is cut into sheets. These sheets can be held in frames made of ceramic materials in order to place the paper fixed into an autoclave. The heat treatment process in an autoclave can be done analogous to a heating process for the production of carbon fibers. These cloths, or sheets, which are now in the form of a microporous carbon product, can now be provided with a catalyst coating and be subjected to other coatings or refinements.

A number of known polymer materials can be fibrillated, and not just those mentioned, but crystalline polymers, such as PET, cannot be fibrillated. The general process of forming a pulp has been known for a long time and is described in the technical literature, as has the fact that paper can be produced from it with the help of traditional paper-making machines.

A fibrous, flat and ion-permeable material made of synthetic fibers, in particular of synthetically spun fibers, such as acrylic fibers or aramid fibers, is processed into staple fibers of a specific length and then fibrillated. In a wet-laid inclined wire machine (paper machine), the fibrillated fibers are formed into a continuous web, and the web or sections thereof are subjected to a temperature treatment and a preferably simultaneous calendaring process. The temperature treatment melts the staple fibers at least partially so that more dense micro-porous layers result on the surface. The webs, which consist at least in part of electrically non-conducting synthetic fibers, are made to be electrically conducting by carbonizing (graphitizing) the web, i.e. the electrically non-conducting synthetic fibers, under heat.

A fibrous, flat and ion-permeable material made of synthetic fibers, in particular of synthetically spun fibers such as acrylic fibers or aramid fibers, is processed into staple fibers of a specific length and then fibrillated. In a wet-laid inclined machine (paper machine), the fibrillated fibers are formed into a continuous web and then the web or portions of it are subjected to a temperature treatment to make the web electrically conducting by carbonizing/graphitizing the web through heating.

Legand:

11 Fuel cell
17 Anode
19 Cathode
21 Proton-permeable, electrically non-conducting membrane
23 Electrical circuit
25a Conventional gas diffusion layer
25b Gas diffusion layer according to the invention
27 Carbon fiber web
29 Carbon impregnation
30 Platinum layer
31 Synthetic fibers of the gas diffusion layer 23b
33 Denser, micro-porous cover layer of the gas diffusion layer 25b
35 Fibrous, porous core of the gas diffusion layer 25b

1. A process to manufacture a fibrous, flat and electronically conducting material made of synthetic fibers, in particular synthetically spun fibers (e.g. acrylic fibers), comprising the steps of
first fibrillating staple fibers having preferably a specific length;
forming the fibrillated staple fibers into a continuous web in a paper manufacturing process, preferably by means of an inclined wire wet laid paper machine,
characterized in that,
the continuous web is calendared at least once prior to its carbonization and then carbonized/graphitized through heating at a temperature of greater than 600° C., to obtain electrical conductivity.

2. A process according to claim 1, characterized in that the carbonization takes place at a temperature greater than 800° C., and very much preferred greater than 1000° C.

3. A process according to claim 1, characterized by an initial first temperature treatment that at least partially softens or melts the fibres.

4. A process according to claim 1, characterized in that the flat material is fixed in a tenter frame prior to the carbonization process.

5. A process according to claim 1, characterized in that the staple fibers are suspended in a solvent, preferably water, to form a pulp and are then fibrillated.

6. A process according to claim 1, characterized in that the fibers are fibrillated in a refiner.

7. A process according to claim 5, characterized in that the pulp dilution in the refiner is approximately 0.1 to 0.01%, preferably 0.05 to 0.02%.

8. A process according to claim 1, characterized in that a mixture of fibrillated and non-fibrillated fibers is used.

9. A process according to claim 1, characterized in that the fibrillated fibers are processed into webs with, a substance weight typically between 45 to 150 g/m².

10. A process according to claim 1, characterized in that fibers with a Titer of up to 15 dtex maximum, preferably up to 8 dtex maximum and especially preferred with a Titer of up to 3.0 dtex maximum are used.

11. A process according to claim 1, characterized in that fibers with cut lengths between 4 and 40 mm, preferably between 8 and 12 mm are used to produce the continuous web.

12. A process according to claim 1, characterized in that synthetic fibers of at least a first and a second type are used.

13. A process according to claim 12, characterized in that the fibers of a second type contain fractions of at least one noble metal or other additive, e.g. a synthetic additive.

14. A process according to claim 1, characterized in that the calendaring is carried out at raised temperatures.

15. A process according to claim 1, characterized in that the web or material is calendared at least twice prior to the carbonization and such that all of the material is densified in a first calendaring step and at least one of the two opposite paper surfaces is changed into a film-like, porous material by melting the fibrillated fibers in a second calendaring step.

16. A process according to claim 1, characterized in that the heat and pressure are selected. such that the calendared micro porous material has pore sizes of <5 μm, preferably <2 μm.

17. A process according to claim 1, characterized in that synthetic fibers such as acrylic or Aramid fibers are used.

18. A process according to claim 1, characterized in that non-crystalline fibers are used as synthetic fibers.

19. A fibrous, flat and porous material obtained from a process according to claim 1 further characterized in that the material has a core having a first porosity and at least one cover layer having a second porosity, said second porosity being less porous than the first porosity.

20. A material according to claim 19, characterized by a fibrous core and at least one micro porous flat cover layer on one side of the material that is more dense than the fibrous region.

21. A material according to claim 19, characterized in that the surfaces of the material opposite one another are micro porous flat cover layers that are more dense than the fibrous region.

22. Non-woven fabric comprising carbonized/graphitized polymeric fibres characterized in that the fabric has a core having a first porosity and at least one cover layer having a second porosity, said second porosity being less porous than the first porosity.

23. Non-woven fabric according to claim 22, characterized in that the fabric consists essentially of carbonized/graphitized polymeric fibres.

24. Non-woven fabric according to claim 22, characterized in that, the fabric is coated with a catalyst layer

25. Non-woven fabric according to one of characterized in that, the fabric is micro porous.

26. Non-woven fabric according to claim 22, characterized in that, the fabric is made from one single web or layer.

27. Non-woven fabric according to claim 22, characterized in that, such a fabric is made from two or more single webs and laminated to a single web.

28. Fuel cells containing at least two gas diffusion layers separated by an ionically-electrically conducting layer separating wall (PEM membrane), said gas diffusion layers being coated with at least one catalyst. characterized in that, each gas diffusion layer is formed at least in part from a material having a fibrous core and at least one micro porous flat cover layer on one side of the material that is more dense than the fibrous region and a non-woven fabric consists essentially of carbonized/graphitized polymeric fibres.

29. Use of a material obtained according to claim 1 and a non-woven fabric comprising carbonized/graphitized Polymeric fibres characterized in that the fabric has a core having a first porosity and at least one cover layer having a second Porosity, said second porosity being less porous than the first porosity as a micro porous support for a membrane, in particular a PEM membrane.
